(19) United States
(12) Patent Application Publication
(10) Pub. No.: US 2025/0245754 A1
(43) Pub. Date: Jul. 31, 2025

(54) METHOD AND SYSTEM OF AUTOMATIC DATA FORECASTING

(71) Applicant: Coupa Software Incorporated, San Mateo, CA (US)

(72) Inventors: Adrien Dumont, Ettenheim (DE); Ahmad Saddedin, San Francisco, CA (US); Himica Kumar, San Mateo, CA (US); Tatjana Sobot, Ettenheim (DE)

(21) Appl. No.: 18/613,789

(22) Filed: Mar. 22, 2024

Related U.S. Application Data
(60) Provisional application No. 63/491,790, filed on Mar. 23, 2023.

(51) Int. Cl. G06Q 40/12; G06Q 10/04

(52) U.S. Cl. CPC G06Q 40/12; G06Q 10/04

(57) ABSTRACT

A computer-implemented method for automatically data forecasting a cash flow in a Procure-to-Pay (P2P) process for a company includes receiving historical data and a requisition request from a user, generating three procurement models, predicting and/or determining amounts and transaction data associated with three cycle times, outputting the amounts and transaction data, generating a work order to improve liquidity planning, and displaying the work order on a user interface. Each of the three procurement models is based at least in part on historical data. The first procurement model is based at least in part on a requisition request and predicts requisition-to-purchase-order cycle time data. The second procurement model is based at least in part on a purchase order and predicts purchase-order-to-invoice cycle time data. The third procurement model is based at least in part on an invoice and predicts invoice approval cycle time data.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2021-2022 Coupa Software Incorporated.

### BENEFIT CLAIM

This application claims the benefit under 35 U.S.C. § 119 (e) of provisional application 63/491,790, filed 23 Mar. 2023, the entire contents of which are hereby incorporated herein by reference for all purposes as if fully set forth herein.

### TECHNICAL FIELD

One technical field of the present disclosure is computer-implemented methods of automatic data forecasting. Another technical field is the software-implemented statistical analysis of procure-to-pay (P2P), travel, and expense data.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

Traditional electronic procurement systems allow purchaser procurement systems to interface directly with seller retail systems in order to provide streamlined interfaces for searching, selecting, and purchasing goods and services. Vendors have made a lot of efforts to extend traditional e-procurement systems to a mobile environment to streamline the steps of a procure-to-pay (P2P) process. For example, the P2P process may be a complex process that includes many individual components that occur across different functional departments of a company with operations in different geographies. As another example, the P2P cycle may include the whole process from the point of a purchase order (PO) to payment, spanning the activities of requisitioning, purchasing, receiving, paying for, and accounting for goods and services. However, the traditional P2P process is time-consuming, labor-intensive, and subject to different disruptions due to financial problems, cyber-attacks, and outages in service suppliers and logistics providers. An automated P2P process is helpful to establish end-to-end visibility of supply chains, evaluate various options in order to mitigate crisis situations, minimize potential human errors, increase transparency, and reduce overall costs for the company.

For example, treasurers need to ensure there is the right amount of money on the right account in the right currency. Thus, it is essential to know how much money is spent and when it is spent from different bank accounts. The automated P2P process may efficiently obtain early information of spend from invoices, which are typically hard to get from the enterprise resource planning (ERP) system(s) for all entities within the company group. Knowing all spend is helpful for the treasurers to balance different bank accounts correctly and efficiently. Likewise, the early information of invoice data provides an opportunity for the treasurers to find more options to invest or borrow money, thereby helping them to save costs or to gain high interest for investments. Based on the foregoing, the referenced technical fields have developed an acute need for better ways to help the treasurers assess cash flow information of spend based on the invoice data available in the business spend management system for making better decisions.

### SUMMARY

The appended claims may serve as a summary of the invention.

### BRIEF DESCRIPTION OF THE DRAWINGS

In the drawings:

FIG. 1 shows a P2P system using an automatic data forecasting manager in accordance with one or more embodiments.

FIG. 2A shows an example of historical data of requisition-to-purchase-order cycle time in days in accordance with one or more embodiments.

FIG. 2B shows an example of a Gaussian distribution to match the historical data of requisition-to-purchase-order-approval cycle times in days in accordance with one or more embodiments.

FIG. 2C shows an example of a Gaussian distribution in accordance with one or more embodiments.

FIG. 3 shows a flow chart of a method of determining a cash flow forecast in a P2P process for a company in accordance with one or more embodiments.

FIG. 4 shows a flow chart of a method of determining a requisition-to-purchase-order-approval cycle time and a purchase-order-to-invoice cycle time in a P2P sub-process for a company in accordance with one or more embodiments.

FIG. 5 shows a flow chart of a method of determining one or more invoice approval cycle times based on different payment terms in a P2P sub-process for a company in accordance with one or more embodiments.

FIG. 6A, shown in sheets labeled FIG. 6A-1, FIG. 6A-2, FIG. 6A-3, and FIG. 6A-4, shows an example of forecasting a date value and an amount for one or more company accounts for three consecutive dates in a P2P process for a company in accordance with one or more embodiments.

FIG. 6B shows an example of forecasting amounts for three company accounts in a P2P process for a company in accordance with one or more embodiments.

FIG. 7 illustrates a computer system in accordance with one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program the computer to implement the claimed inventions, at the same level of detail that is used by people of skill in the arts to which this disclosure pertains to communicate with one another concerning functions to be programmed, inputs, transformations, outputs, and other aspects of programming. That is, the level of detail set forth in this disclosure is the same level of detail that persons of skill in the art normally use to communicate with one another to express algorithms to be programmed or the structure and function of programs to implement the inventions claimed herein.

One or more different inventions may be described in this disclosure, with alternative embodiments to illustrate examples. Other embodiments may be utilized and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more of the inventions nor a listing of features of one or more of the inventions that must be present in all embodiments.

Headings of sections and the title are provided for convenience but are not intended as limiting the disclosure in any way or as a basis for interpreting the claims. Devices that are described as in communication with each other need not be in continuous communication with each other unless expressly specified otherwise. In addition, devices that are in communication with each other may communicate directly or indirectly through one or more intermediaries, logical or physical.

A description of an embodiment with several components in communication with one another does not imply that all such components are required. Optional components may be described to illustrate a variety of possible embodiments and to fully illustrate one or more aspects of the inventions. Similarly, although process steps, method steps, algorithms, or the like may be described in sequential order, such processes, methods, and algorithms may generally be configured to work in different orders, unless specifically stated to the contrary. Any sequence or order of steps described in this disclosure is not a required sequence or order. The steps of described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or some occurrences, or some steps may be executed more than once in a given embodiment or occurrence. When a single device or article is described, more than one device or article may be used in place of a single device or article. Where more than one device or article is described, a single device or article may be used in place of more than one device or article.

The functionality or features of a device may be alternatively embodied by one or more other devices that are not explicitly described as having such functionality or features. Thus, other embodiments of one or more of the inventions need not include the device itself. Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

Embodiments are described in the sections below according to the following outline:
1. GENERAL OVERVIEW
2. STRUCTURAL AND FUNCTIONAL OVERVIEW
   2.1 DISTRIBUTED COMPUTER SYSTEM EXAMPLE
   2.2 EXAMPLE DATA PROCESSING FLOW
3. PROCEDURAL OVERVIEW
4. IMPLEMENTATION EXAMPLE
5. HARDWARE OVERVIEW

### 1. General Overview

In an embodiment, a computer-implemented method can be programmed for automatic data forecasting a cash flow from procure-to-pay (P2P), travel, and/or expense objects for a company of interest. The cash flow includes an amount and a date value which comprise various cash flow cycle times, such as requisition-to-purchase-order cycle time, purchase-order-to-invoice cycle time, invoice approval cycle time, and other due dates in cash management for the company. For example, when a requisition is created, the computer-implemented method can automatically calculate a forecast, determine that the invoice is received/approved, or determine that the payment is due. The computer-implemented method can constantly update different date values and amounts in the P2P process when a transaction advances or some of the forms/documents of the transaction are modified or rejected.

Furthermore, the computer-implemented method can automatically calculate a date value and an amount based on historical records of one or more of customer data, travel data, expense data, and/or CCW/Maestro objects for the company and/or community data from other customers. Thus, the computer-implemented method can apply a statistical analysis algorithm to forecast one or more elements, such a date value, an amount, and/or a cost of contingent workers, of a cash flow in the P2P process using the available historical records to provide useful information for a user, such as a treasurer. Specifically, the forecast information can be evaluated to generate a work order to improve the short-term and long-term business goals of the company. For example, the forecast information can be used to find accounts for spending on a certain day or a period of time, such as two weeks. As another example, the forecast information can be used for long-term liquidity planning for the company. In some embodiments, the computer-implemented method can be performed by applying the work order on multiple ERP systems to consolidate the total number of vendors and to streamline business expenditures by lowering the overall requisition costs both externally and internally.

### 2. Structural and Functional Overview

### 2.1 Distributed Computer System Example

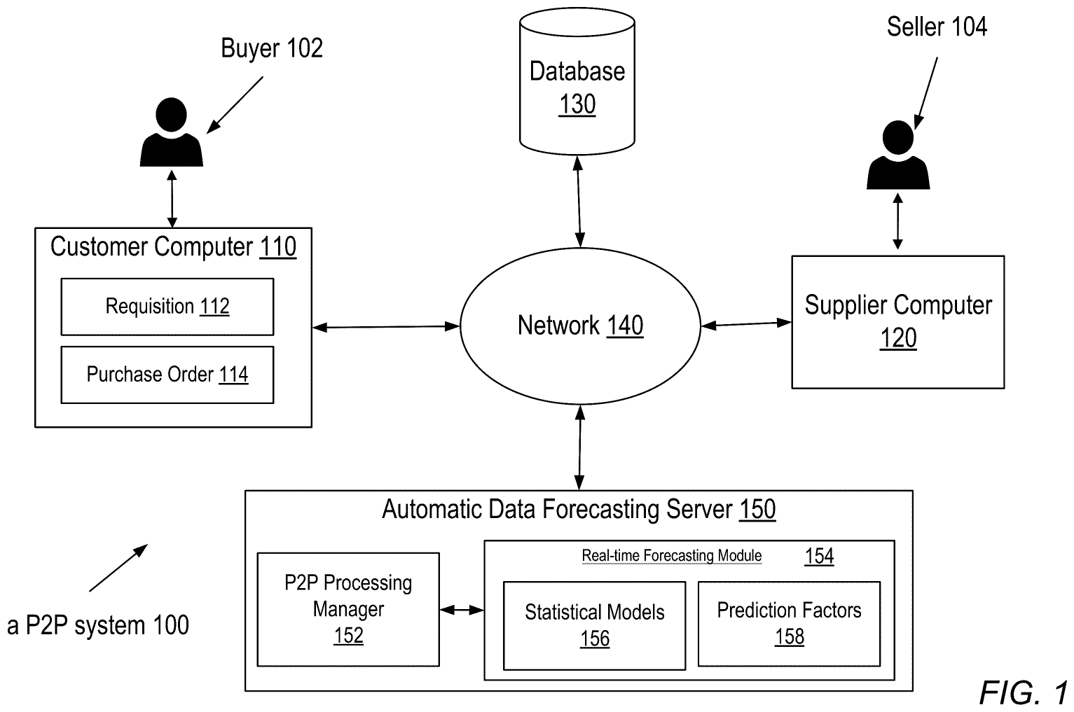

FIG. 1 illustrates a distributed computer system showing the context of use and principal functional elements with which one embodiment could be implemented. In an embodiment, a P2P system 100 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of assessing a cash flow in a P2P process in order to help treasurers to make better decisions to save costs or gain higher interests for investments. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

FIG. 1 shows a P2P system using an automatic data forecasting manager in accordance with one or more embodiments. The automatic data forecast manager may be used to implement disclosed embodiments, including exemplary system components. The components and arrangement, however, may be varied. While FIG. 1 shows various configurations of components, other configurations may be used without departing from the scope of the disclosure. For example, various components in FIG. 1 may be combined to create a single component. As another example, the functionality performed by a single component may be performed by two or more components.

In the example of FIG. 1, the P2P system 100 is configured for predicting a cash flow for a customer, such as a buyer 102, and a supplier, such as a seller 104. The P2P system 100 may include a customer computer 110 associated with the buyer 102, a supplier computer 120 associated with the seller 104, an automatic data forecasting server 150 that is programmed for automatic forecasting, a database 130, and a network 140. The P2P system 100 may be implemented in various ways. The P2P system 100 may be a general-purpose computer, a server, a mainframe computer, or any combination of these components. The buyer 102 can use the customer computer 110 to access the P2P system 100 through network 140, which broadly represents any wireline or wireless network, using satellite or terrestrial network links, such as local area networks (LANs), metropolitan area networks (MANs), wide area networks (WANs), campus network, internetworks, or combinations thereof. The network 140 may include or comprise the public internet and networked server computers that implement Web2 and/or Web3 technologies. Network 140 may comprise or support intranets, extranets, or virtual private networks (VPNs). The P2P system 100 may be standalone or it may be part of a subsystem, which may, in turn, be part of a larger system, such as a legacy procurement system.

In some embodiments, the customer computer 110 broadly represents one or more computers, virtual computing instances, and/or instances of an e-procurement application program that are associated with an institution or entity. The customer computer 110 is programmed to create a buyer account with the automatic data forecasting server 150 and manage digital documents related to a buyer account during procurement transactions, such as receiving a catalog of items for sale from the automatic data forecasting server 150, generating or transmitting a purchase requisition 112 or purchase order 114 for some of the items for sale to the automatic data forecasting server 150, or receiving an invoice for some of the items for sale from the automatic data forecasting server 150. A purchase requisition is a form that a company produces internally and submits to the purchasing department of the company. A purchase order is generated when the purchasing department approves the received requisition request. The customer computer 110 may comprise a desktop computer, laptop computer, tablet computer, smartphone, wearable device, or any other type of computing device that is capable of proper communication with the automatic data forecasting server 150 as well as adequate local data processing and storage. In some cases, a customer computer 110 may be a personal computer or workstation that hosts or executes a browser and communicates via HTTP and HTML over network 140 with a server-side e-procurement application hosted or executed at the automatic data forecasting server 150. In other cases, a customer computer 110 may be a server-class computer and/or virtual computing instance that hosts or executes an instance of an e-procurement application that communicates programmatically via API calls, RPC, or other programmatic messaging with the automatic data forecasting server 150.

In some embodiments, the supplier computer 120 broadly represents one or more computers, virtual computing instances, and/or instances of an e-procurement application program that are associated with an institution or entity. The supplier computer 120 is programmed to create a supplier account with the automatic data forecasting server 150 and manage digital documents related to a supplier account during procurement transactions, such as receiving a purchase order from the automatic data forecasting server 150, generating or transmitting an invoice for some of the items for sale to the automatic data forecasting server 150, or receiving payment for some of the items for sale from the automatic data forecasting server 150. The supplier computer 120 may comprise a desktop computer, laptop computer, tablet computer, smartphone, wearable device, or any other type of computing device that is capable of proper communication with the automatic data forecasting server 150 as well as adequate local data processing and storage. In some cases, a supplier computer 120 may be a personal computer or workstation that hosts or executes a browser and communicates via HTTP and HTM over network 140 with a server-side e-procurement application hosted or executed at the automatic data forecasting server 150. In other cases, a supplier computer 120 may be a server-class computer and/or virtual computing instance that hosts or executes an instance of an e-procurement application that communicates programmatically via API calls, RPC, or other programmatic messaging with the automatic data forecasting server 150.

The customer computer 110 and the supplier computer 120 can enable intelligent online navigation of product information based on data related to past online activities regarding the products, such as selections, requisitions, purchases, invoices, or payments. For example, a requisition is a request for goods and services made by a customer to a purchasing department in a company. The requisition forms the basis of a purchase order which is a commercial document that confirms an order and authorizes the purchase transaction for goods or services from a supplier. As another example, a purchase order includes information regarding one or more of date(s), price(s), delivery status(es), and any additional one or more different agreed terms and conditions (such as discounts, a purchase order number, and/or the timeframe for payment). Seller 104 via the supplier computer 120 can send an invoice for payment to the company. As a result, the automatic data forecasting server 150 can enable intelligent preparation and processing of product queries to enhance the procurement experience for specific groups of users or procurement targets for the buyer 102 and the seller 104.

In some embodiments, the automatic data forecasting server 150 broadly represents one or more computers, such as a server farm, a cloud computing platform, a parallel computer, virtual computing instances, and/or instances of a server-based application. The server 150 comprises a P2P processing manager 152 that is programmed or configured to host or execute functions including but not limited to (1) managing customer accounts associated with the one or more customer computers 110 and supplier accounts associated with the one or more supplier computers 120 and (2) facilitating generation and maintenance of digital documents during procurement transactions between customer accounts and supplier accounts, such as catalogs, purchase requisitions, purchase orders, invoices, and payments. The automatic data forecasting server 150 also comprises a real-time forecasting module 154 that is programmed or configured to host or execute functions including, but not limited to, providing real-time automatic data forecasting for electronic procurements.

The automatic data forecasting server 150 can implement a P2P processing manager 152 which is programmed to obtain requisition request(s) and/or purchase order(s) from the customer computer 110. For example, the P2P processing manager 152 can receive notifications, review requisitions and other related documents, and approve requisitions and other related documents. As another example, the P2P process manager 152 can monitor the end-to-end process beginning with the requisition and purchase of goods and services and ending with payment for those goods and services. In particular, the P2P process manager 152 can implement a multi-level hierarchy framework corresponding to one or more criteria, such as managing record requisition and purchase, managing inbound documents, recording good receipts, processing payments, addressing customer inquiries, handling disputes and exceptions, etc. In particular, the P2P processing manager 152 can update the historical data of P2P, travel, and expense objects stored in the database 130. The historical data may be associated with events in the P2P process. Thus, the P2P processing manager 152 can ensure that all requests for requisitions 112 and purchase orders 114 are registered, purchase and sales invoices are processed, payments are submitted, and invoice and other records are stored. Likewise, the P2P processing manager 152 can continuously update historical data of P2P, travel, and expense objects from different sources, such as company proprietary data and/or community data collected from other customers with consent and on a de-identified basis. In some embodiments, the P2P processing manager 152 can obtain the historical data as de-identified community data from a plurality of enterprises. The historical data may be industry-specific, supplier-specific, or spend-specific, historical data from P2P process, travel, and expense objects from one or more of an e-procurement application, travel application, and expense application of a federated system in which the method executes, and the historical data can comprise records digitally stored in the database 130 with column attributes for industry, supplier, and spend amount.

The automatic data forecasting server 150 can implement a forecasting module 154 which is programmed to forecast cash flow information (such as a date value and an amount) based on P2P, travel, and expense objects obtained by the P2P processing manager 152. For example, the forecasting module 154 is programmed to assess the progress of a transaction, such as receiving a requisition request, generating a purchase order, receiving an invoice, and approving an invoice. As another example, the forecasting module 154 can apply a statistical analysis algorithm to generate a statistical model based on historical records stored in the database 130. For example, the forecasting module 154 can forecast a date value and an amount using a Gaussian distribution known as the “bell curve” or normal distribution (Equation 1). In particular, the forecasting module 154 can predict a date value, a probability of the date value, an amount, an estimated period of possible days at two standard deviations. Equation 1 is as follows:

$$f ( x ) = \frac{1}{\sqrt{2 π} σ} {e}^{- \frac{1}{2} {( \frac{x - μ}{σ} )}^{2}} \qquad Equation 1$$

where f(x) is the probability density function of the Gaussian distribution, σ is the standard deviation of the Gaussian distribution and u is the mean of the Gaussian distribution.

The forecasting module 154 can determine one or more parameters of one or more statistical models 156 using one or more prediction factors 158. Each of the statistical models 156 can be implemented using a trained machine learning model, such as a linear classifier, or using a programmatically callable function that is programmed using a statistical function capable of reading and interpreting a plurality of historical records of transactions in the database 130. The prediction factors 158 can be obtained from previous experience in procurement management for the company. For example, the forecasting module 154 can estimate an amount based on the received purchase order. The forecasting module 154 can estimate a date value of when a payment will happen and a possibility of the date value based on a mean value and the possibility at the mean value in the statistical model 156. Likewise, the forecasting module 154 can estimate an estimated period of possible days of when a payment will happen with a certain possibility, such as a confidence level of 95%, based on the period of estimated payment days in the statistical model 156 for two standard deviations. The probability value measures the number of occurrences that have happened with the predicted duration period of payment days with respect to the number of total occurrences.

The forecasting module 154 can determine a statistical model for each type of spending, suppliers, customers, and approvals. For example, the forecasting module 154 can determine a first, second, and third statistical model for requisition-to-purchase-order-approval cycle time, purchase-order-to-invoice cycle time, and invoice approval cycle time for a supplier or a customer. Between these predicted cycle times, the forecasting module 154 can use invoice both date and payment terms to calculate other duration periods of payment days for a spend, a customer, a supplier, and an approver. In particular, the forecasting module 154 can determine a fourth, fifth, and sixth statistical model for invoice-to-payment-batch cycle time, invoice-payment-batch-approval cycle time, and batch release cycle time for a spend and an approver. An invoice-to-payment-batch cycle time is determined from the time when an invoice is approved to the time when a payment batch including the invoice is submitted for approval. An invoice-payment-batch-approval cycle time is determined from the time when an invoice is approved to the time when a payment batch is approved. A batch release cycle time is determined from the time when an invoice is approved to the time when a payment batch is released. As a result, the automatic data forecasting server 150 can compare the predicted information to community data from other customers to derive quality factors related to the P2P system for decision-making and increasing business values for the company.

Each of the functional components of the P2P system 100 can be implemented as software components, general or specific-purpose hardware components, firmware components, or any combination thereof. A storage component, such as database 130, can be implemented using any form of storage selected from among relational databases, object databases, flat file systems, or JSON stores. A storage component can be connected to the functional components locally or through the networks using programmatic calls, remote procedure call (RPC) facilities, or a messaging bus. A component may or may not be self-contained. Depending upon implementation-specific or other considerations, the components may be centralized or distributed functionally or physically.

### 2.2 Example Data Processing Flow

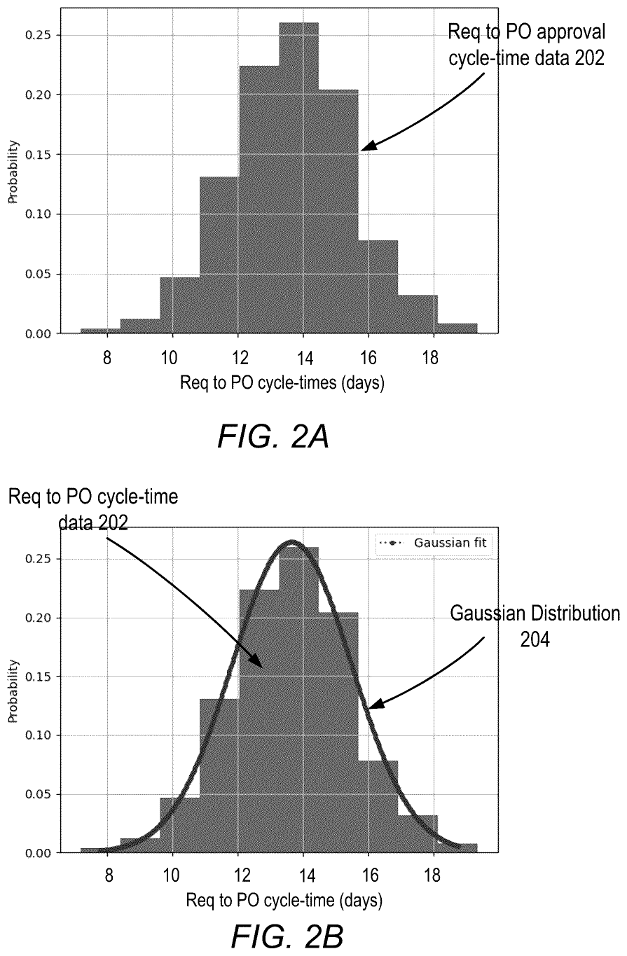

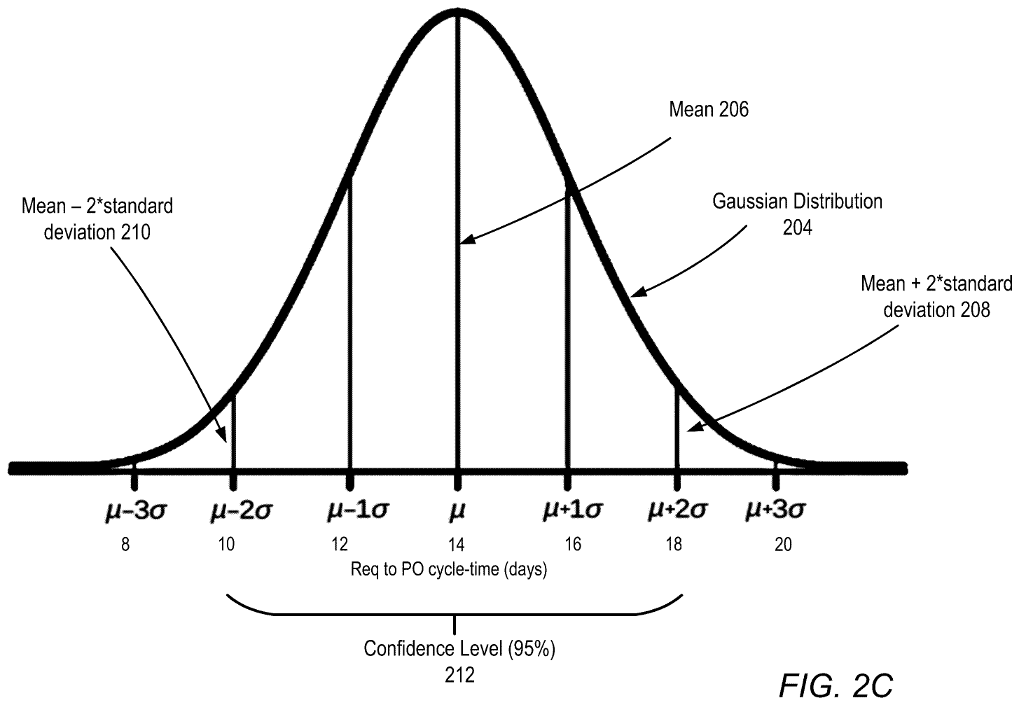

FIG. 2A, FIG. 2B, and FIG. 2C illustrate an example process for generating a statistical model based on historical data of P2P, travel, and expense objects for a company. FIG. 2A, FIG. 2B, and FIG. 2C, and each other flow diagram herein is intended as an illustration of the functional level at which skilled persons, in the art to which this disclosure pertains, communicate with one another to describe and implement algorithms using programming. The flow diagrams are not intended to illustrate every instruction, method object or sub-step that would be needed to program every aspect of a working program, but are provided at the same functional level of illustration that is normally used at the high level of skill in this art to communicate the basis of developing working programs.

FIG. 2A shows an example of historical data of requisition-to-purchase-order cycle time in days in accordance with one or more embodiments. In particular, FIG. 2A shows an example of a histogram of historical records of requisition-to-purchase-order-approval cycle times 202 for a spend, a customer, and a supplier. In particular, the automatic data forecasting server 150 can remove outlier data samples given that the requisition-to-purchase-order-approval cycle times are consistent with physical quantities with expected value ranges. Likewise, the automatic data forecasting server 150 can normalize the requisition-to-purchase-order-approval cycle times by the total requisition-to-purchase-order-approval cycle times for the spend, the customer, and the supplier.

FIG. 2B shows an example of a Gaussian distribution to match the historical data of requisition-to-approval cycle times in days in accordance with one or more embodiments. In particular, FIG. 2B shows an example of generating a statistical model based on a Gaussian distribution 204 to match the histogram of historical records of requisition-to-purchase-order-approval cycle times 202. Specifically, a best-fit Gaussian distribution 204 can be determined using an objective function to minimize a least-squared error between the Gaussian distribution 204 and the histogram of historical records of requisition-to-purchase-order-approval cycle times 202. Likewise, a best-fit high-order multi-dimensional Gaussian distribution 204 can be determined for one or more prediction factors, such as spending, customers, suppliers, and approvers, etc. The statistical model may be generated by one of many methods well known to one of ordinary skill in the art. For example, and without limitation, any one or more of a Bernoulli distribution, a uniform distribution, a Binomial distribution, a Poisson distribution, or an exponential distribution may be used. The prediction factors 158 of the statistical model 156, such as mean, standard deviation, variance, correlation coefficient, etc., may be generated using kriging, gridding, or machine learning regression.

FIG. 2C shows an example of a Gaussian distribution in accordance with one or more embodiments. In particular, FIG. 2C shows an example of a probability of different requisition-to-purchase-order-approval cycle times from 8 days to 20 days for the spend, the customer, and the supplier. For example, a purchase order may be estimated to be approved in 14 days if a requisition is received based on mean value 206 of the Gaussian distribution 204. As another example, a purchase order may be estimated to be approved in a duration period from a date value of (mean−2*standard deviation) 210, such as 10 days, to a date value of (mean+2*standard deviation) 208, such as 18 days, with a 95% confidence level 212 based on a standard deviation of 2 days and the mean 206 of the Gaussian distribution 204.

### 3. Procedural Overview

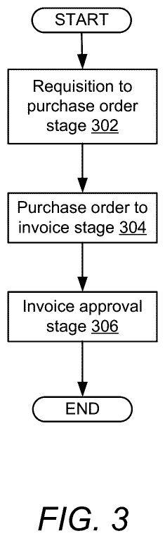

FIG. 3 show a flow chart of a method of determining a cash flow forecast in a P2P process for a company in accordance with one or more embodiments. FIG. 3 can be programmed to implement a general workflow to apply a statistical model to assess historical data of P2P, travel, and expense for a company. One or more blocks in FIG. 3 may be performed by one or more components as described in FIG. 1 and FIG. 2A, FIG. 2B, and FIG. 2C; for example, the automatic data forecasting server 150 can be programmed using one or more sequences of instructions to execute an implementation of FIG. 3. While the various blocks in FIG. 3 are presented and described sequentially, one of ordinary skill in the art will appreciate that some or all of the blocks may be executed in different orders, combined or omitted, and/or executed in parallel. Furthermore, the blocks may be performed actively or passively.

FIG. 3 and each other flow diagram herein is intended as an illustration of the functional level at which skilled persons, in the art to which this disclosure pertains, communicate with one another to describe and implement algorithms using programming. The flow diagrams are not intended to illustrate every instruction, method object, or sub-step that would be needed to program every aspect of a working program, but are provided at the same functional level of illustration that is normally used at the high level of skill in this art to communicate the basis of developing working programs.

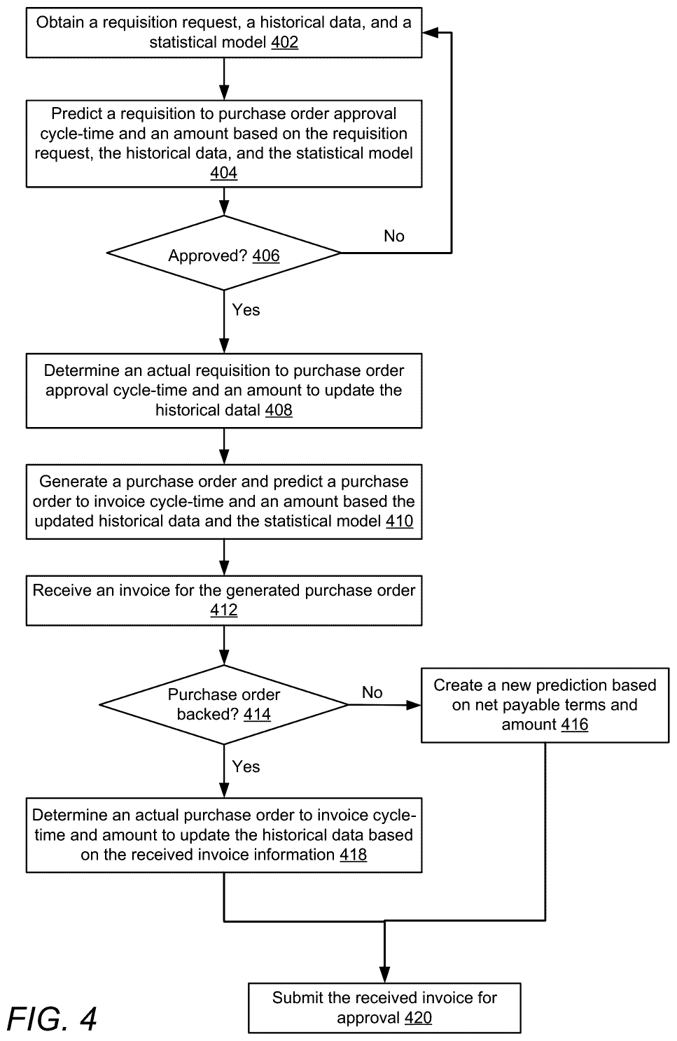

In Block 302, a requisition-to-purchase-order stage is implemented in a P2P process for a company in accordance with one or more embodiments. For example, a P2P system 100 obtains a requisition request from a customer. The automatic data forecasting server 150 can predict a date value and an amount of requisition-to-purchase-order-approval cycle time based on the received requisition request and historical data of P2P, travel, and expense objects stored in the database 130. As another example, the automatic data forecasting server 150 can determine an actual requisition-to-purchase-order-approval cycle time for the spend and the customer when the purchase order is generated. The automatic data forecasting server 150 can use the actual requisition-to-purchase-order-approval cycle time for the spend and the customer to update the historical data of P2P, travel, and expense objects stored in the database 130. The date value and the amount of the requisition-to-purchase-order-approval cycle time are described below in FIG. 4 and the accompanying description.

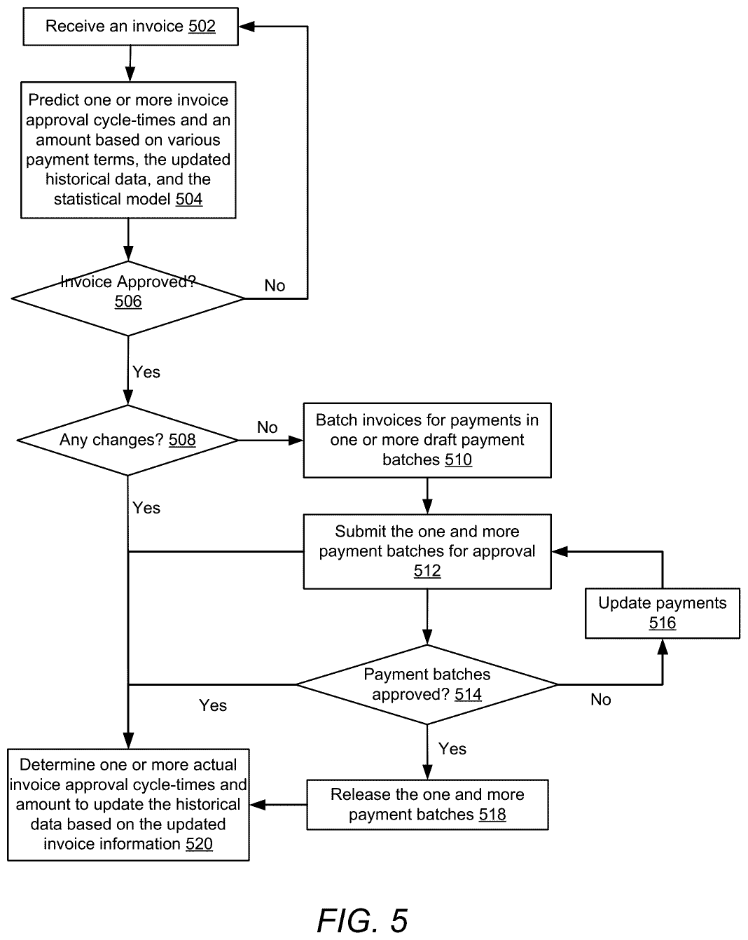

In Block 304, a purchase-order-to-invoice stage is implemented in the P2P process for the company in accordance with one or more embodiments. When the purchase order based on the purchase requisition request is approved, the purchase order is issued and sent to a supplier for processing. The automatic data forecasting server 150 can predict a date value and an amount of purchase-order-to-invoice cycle time based on the received invoice and historical data of P2P, travel, and expense objects stored in the database 130. The supplier can send an invoice as a request for payment to the purchasing department of the company. As another example, the automatic data forecasting server 150 can determine an actual purchase-order-to-invoice cycle time for the spend and the customer when the invoice is received at the purchasing department of the company. The automatic data forecasting server 150 can use the actual purchase-order-to-invoice cycle time for the spend and the customer to update the historical data of P2P, travel, and expense objects stored in the database 130. The date value and the amount of the purchase-order-to-invoice cycle time are described below in FIG. 5 and the accompanying description.

In Block 306, an invoice approval stage is implemented in the P2P process for the company in accordance with one or more embodiments. The invoice approval stage includes a set of steps before an invoice is paid based on payment terms. For example, the invoice approval process includes a payment batch subprocess, a payment batch approval subprocess, and a batch release subprocess. Likewise, the automatic data forecasting server 150 can predict a date value and a confidence level for each invoice approval cycle time depending on payment terms, such as invoice-to-payment-batch cycle time, invoice-payment-batch-approval cycle time, and batch release cycle time. As another example, the automatic data forecasting server 150 can determine an actual cycle time for each of invoice approval cycle times depending on payment terms and update the historical data of P2P, travel, and expense objects stored in the database 130. The date values and the amounts of different invoice approval cycle times are described below in FIG. 5 and the accompanying description.

Turning to FIG. 4, FIG. 4 shows a flow chart of a method of determining a requisition-to-purchase-order-approval cycle time and a purchase-order-to-invoice cycle time in a P2P sub-process for a company in accordance with one or more embodiments. One or more blocks in FIG. 4 may be performed by one or more components as described in FIG. 1 and FIG. 2A-2C; for example, the automatic data forecasting server 150 can be programmed using one or more sequences of instructions to execute an implementation of FIG. 4. While the various blocks in FIG. 4 are presented and described sequentially, one of ordinary skill in the art will appreciate that some or all of the blocks may be executed in different orders, combined or omitted, and/or executed in parallel. Furthermore, the blocks may be performed actively or passively.

In Block 402, a requisition request, historical data, and a statistical model are obtained in accordance with one or more embodiments. For example, a requisition may be created on Jan. 1, 2020, with an amount of $1000. The historical data may include records of P2P, travel, and expense from customer data and/or community data. The statistical model may be derived from previous experience based on historical data or a predetermined model chosen by a user, such as a Gaussian distribution.

In Block 404, a requisition-to-purchase-order-approval cycle time and an amount are predicted based on the requisition request, the historical data, and the statistical model in accordance with one or more embodiments. The automatic data forecasting server 150 may estimate a date value and an amount for the requisition-to-purchase-order-approval cycle time based on one or more of the requisition requests, the historical data, and the statistical model. For example, the amount and the value data of the requisition-to-purchase-order-approval cycle time may be estimated to be 1000 dollars and 10 days, such as Jan. 10, 2020, with a possibility value of 40% for the forecast or in the range from 6 days to 16 days, such as Jan. 6, 2020-Jan. 16, 2020, with a possibility value of 95% for two standard deviations.

In Block 406, a determination is made as to whether the requisition request is approved in accordance with one or more embodiments. Where the requisition request is approved, the process may proceed to Block 408. Where the requisition request is not approved, the process may proceed to Block 402.

In Block 408, an actual requisition-to-purchase-order-approval cycle time and an amount are determined to update the historical data in accordance with one or more embodiments. When the requisition request is approved, the automatic data forecasting server 150 can determine the actual requisition-to-purchase-order-approval cycle time based on the date when the requisition request is created. For example, the requisition may actually be approved to generate a purchase order in 11 days on Jan. 11, 2020. The automatic data forecasting server 150 may update the historical data with a value of 11 days for the requisition-to-purchase-order-approval cycle time of the transaction for future predictions.

In Block 410, a purchase order is generated, and a purchase-order-to-invoice cycle time and an amount are predicted based on the updated historical data and the statistical model in accordance with one or more embodiments. The purchase order can be generated based on the approved requisition request and may be sent to the supplier for processing. Likewise, the automatic data forecasting server 150 can estimate a date value and an amount for the purchase-order-to-invoice cycle time for the generated purchase order based on the updated historical data and the statistical model. For example, the amount and the value data of the purchase-order-to-invoice cycle time are estimated to be 1000 dollars and 10 days, such as Jan. 21, 2020, with a possibility value of 60% for the forecast or in the range from 6 days to 16 days, such as Jan. 17, 2020-Jan. 27, 2020 with a possibility value of 95% for two standard deviations.

In Block 412, an invoice is received for the generated purchase order in accordance with one or more embodiments. For example, the supplier receives the purchase order and sends an invoice on Jan. 21, 2020 to the purchasing department of the company for payments.

In Block 414, a determination is made whether the invoice is PO-backed in accordance with one or more embodiments. The received invoice is a PO-backed invoice when the invoice has a purchase order. The received invoice is a non-PO-backed invoice when the invoice does not have a purchase order. A non-PO-backed invoice usually occurs for indirect purchases or spending below the tolerance limit. Where the invoice is PO-backed, the process may proceed to Block 418. Where the invoice is non-PO backed, the process may proceed to Block 416.

In Block 416, a new prediction is created based on net payable terms and amount for the non-PO backed invoice in accordance with one or more embodiments.

In Block 418, an actual purchase-order-to-invoice cycle time and an amount are determined to update the historical data based on the received invoice information in accordance with one or more embodiments. When the received invoice is PO backed, the automatic data forecasting server 150 can determine the actual purchase-order-to-invoice cycle time (for example, 10 days) based on the duration period between the date when the purchase order is created (for example, Jan. 11, 2020) and the date when the invoice is received (for example, Jan. 21, 2020). Likewise, the automatic data forecasting server 150 can use the actual purchase-order-to-invoice cycle time to update the historical data with 10 days for the purchase-order-to-invoice cycle time of the transaction for future predictions.

In Block 420, the received invoice is submitted for approval in accordance with one or more embodiments. The automatic data forecasting server 150 can send the received invoice to the purchasing department of the company for approval in order to issue a payment for the received invoice.

Turning to FIG. 5, FIG. 5 shows a flow chart of a method of determining one or more invoice approval cycle times based on different payment terms in a P2P sub-process for a company in accordance with one or more embodiments. One or more blocks in FIG. 5 may be performed by one or more components as described in FIG. 1 and FIG. 2A-2C; for example, the automatic data forecasting server 150 can be programmed using one or more sequences of instructions to execute an implementation of FIG. 5. While the various blocks in FIG. 5 are presented and described sequentially, one of ordinary skill in the art will appreciate that some or all of the blocks may be executed in different orders, combined or omitted, and/or executed in parallel. Furthermore, the blocks may be performed actively or passively.

In Block 502, an invoice is received in accordance with one or more embodiments. The invoice may include data. For example, without limitation, the invoice may include one or more dates and/or one or more payment terms.

In Block 504, one or more invoice approval cycle times and an amount are predicted based on various payment terms, the updated historical data, and the statistical model in accordance with one or more embodiments. The automatic data forecasting server 150 can estimate a date value and an amount for the one or more invoice approval cycle times for the received invoice based on the updated historical data and the statistical model. Likewise, the automatic data forecasting server 150 can estimate a date value and an amount for the one or more invoice approval cycle times based on various payment terms. For example, the amount and the value data of an invoice approval cycle time are estimated to be 1000 dollars and 10 days, such as Jan. 31, 2020, with a possibility value of 60% for the forecast or in the range from 6 days to 16 days, such as Jan. 27, 2020-Feb. 4, 2020 with a possibility value of 95% for two standard deviations. Similarly, the automatic data forecasting server 150 can estimate a date value and an amount for other invoice approval cycle times based on various payment terms, such as invoice-to-payment-batch cycle time, invoice-payment-batch-approval cycle time, and batch release cycle time.

In Block 506, a determination is made whether the invoice is approved in accordance with one or more embodiments. Where the invoice is approved, the process may proceed to Block 508. Where the invoice is not approved, the invoice may be re-examined and the process may proceed to Block 502.

In Block 508, a determination is made whether the invoice is changed in accordance with one or more embodiments. Where the invoice is changed, the process may proceed to Block 520. Where the invoice is not changed, the process may proceed to Block 510.

In Block 510, invoices are batched for payments in one or more draft payment batches in accordance with one or more embodiments. The automatic data forecasting server 150 can generate an invoice batch by putting together different invoices in a bundle by a payer to be processed as one batch. Thus, invoice batching helps to improve efficiency, reduce human error, and save time and effort by skipping repetitive tasks like data input.

In Block 512, one and more payment batches are submitted for approval in accordance with one or more embodiments. For example, the process may proceed to Block 520 to determine an actual invoice-to-payment-batch cycle time when a predicted invoice-to-payment-batch cycle time is determined in the previous P2P process. As another example, the automatic data forecasting server 150 can generate new forecast for the invoice-to-payment-batch cycle time based on net payable terms and amount when a predicted invoice-to-payment-batch cycle time is not determined in previous P2P process.

In Block 514, a determination is made whether the payment batches are approved in accordance with one or more embodiments. Where the payment batches are approved, the process may proceed to Block 518 and Block 520. Where the payment batches are not approved, the process may proceed to Block 516.

In Block 516, payments are updated in accordance with one or more embodiments. The automatic data forecasting server 150 can modify the payments in the more and more payment batches and resubmit them for approval in Block 512.

In Block 518, one and more payment batches are released in accordance with one or more embodiments. The automatic data forecasting server 150 can use a batch account, such as a company account, to split each of the payment batches between multiple customer accounts in the company.

In Block 520, one or more actual invoice approval cycle times and amounts are determined to update the historical data based on the updated invoice information in accordance with one or more embodiments. For example, the automatic data forecasting server 150 can determine an actual invoice approval cycle time, an invoice-to-payment-batch cycle time, an invoice-payment-batch-approval cycle time, and a batch release cycle time.

### 4. Implementation Example

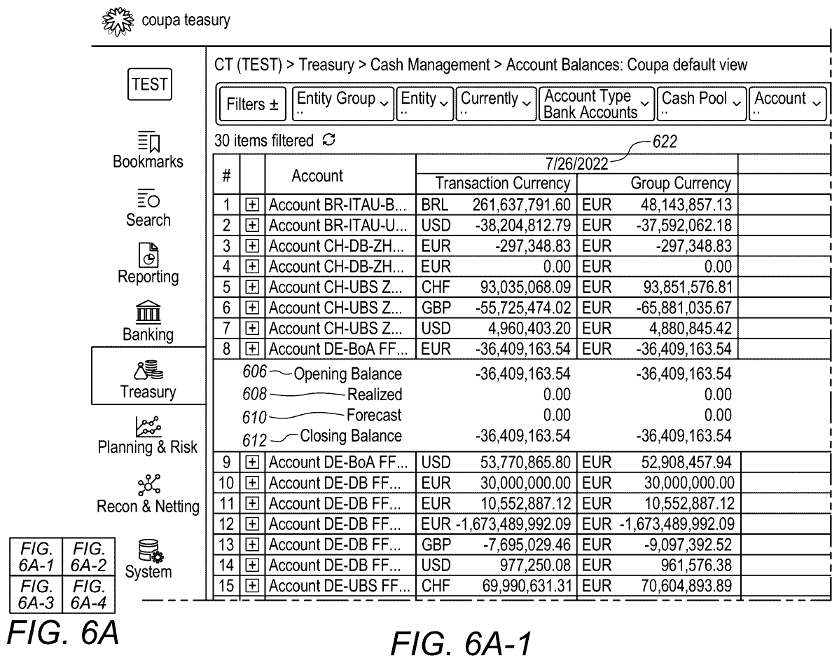

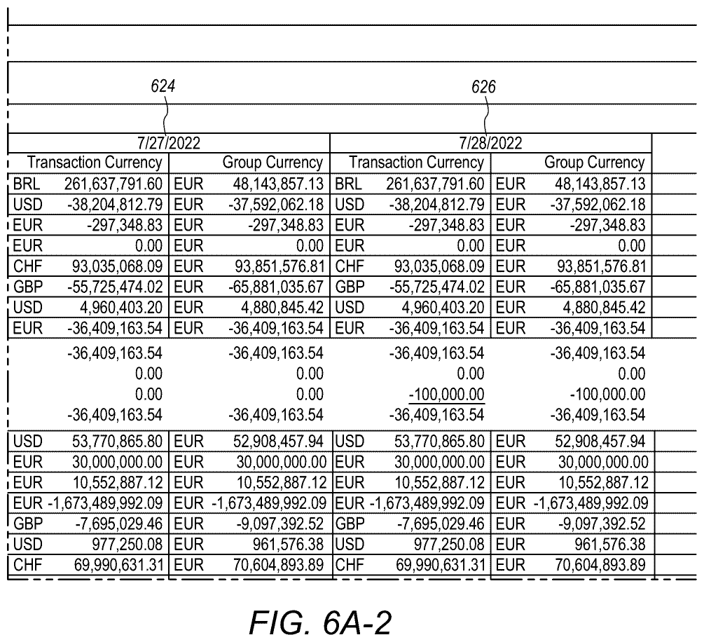

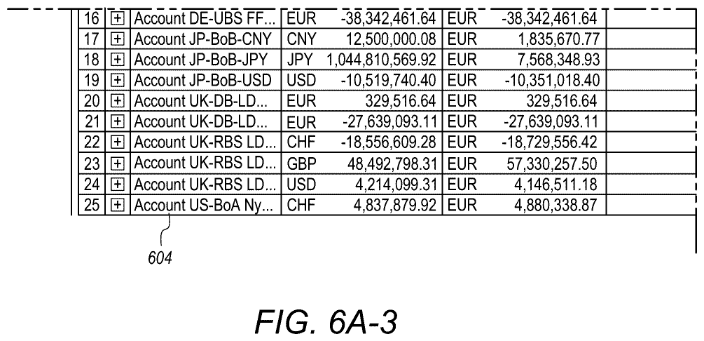

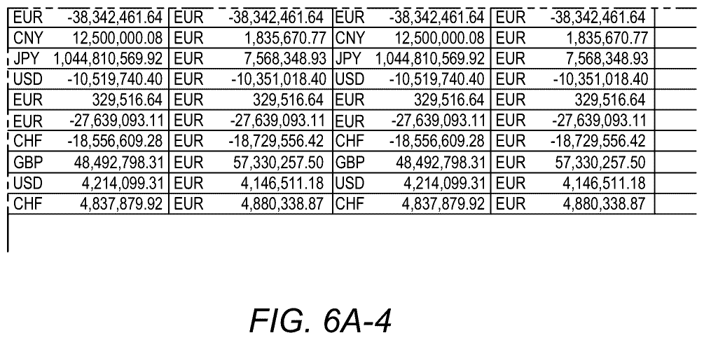

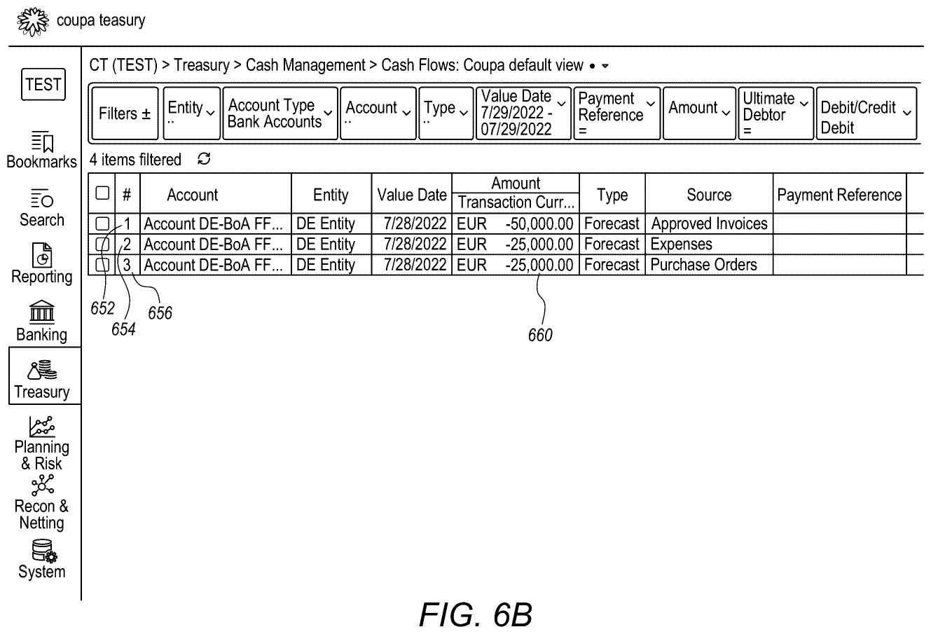

FIG. 6A shows an example of forecasting a date value and an amount for one or more company accounts for three consecutive dates in a P2P process for a company in accordance with one or more embodiments. In one embodiment, FIG. 6A shows an example of opening balance 606, actual transaction amounts 608, predicted transaction amounts 610, and closing balances 612, for an account of the company accounts 604 for both a transaction currency and a group currency, such as US dollar (USD), Euro (EUR), British pound sterling (GBP), Brazilian real (BRL), Swiss Franc (CHF), Chinese Yuan (CNY), Japanese Yen (JPY), etc. The three consecutive dates include Jul. 26, 2022 for the first day date_1 622, Jul. 27, 2022 for the second day date_2 624, and Jul. 28, 2022 for the third day date_3 626. For the company account, the opening balances 606 has a value of 36,409,163.54 and the actual transaction amounts 608 has a value of 0 for all three days. The predicted transaction amounts 610 has a value for date_1 622 and date_2 624, and a value of −100,000 for date_3 626 which suggest a forecasted due date on the date Jul. 28, 2022 with a transaction amount of 100,000. However, the forecasted due dates and the predicted transaction amounts are not all consistent with the actual transaction due dates and the actual transaction amounts. This inconsistency is associated with the predicted date value and the confidence level based on a statistical model and historical data for the transaction due date associated with this company account.

FIG. 6B shows an example of forecasting amounts 660 for three company accounts 652, 654, and 656 in a P2P process for a company in accordance with one or more embodiments. In one embodiment, FIG. 6B shows an example of a predicted amount of −50,000 EUR for a company account 652 for approval invoice, a predicted amount of −25,000 EUR for a company account 654 for expense, and a predicted amount of −25,000 EUR for a company account 656 for purchase orders.

### 5. Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

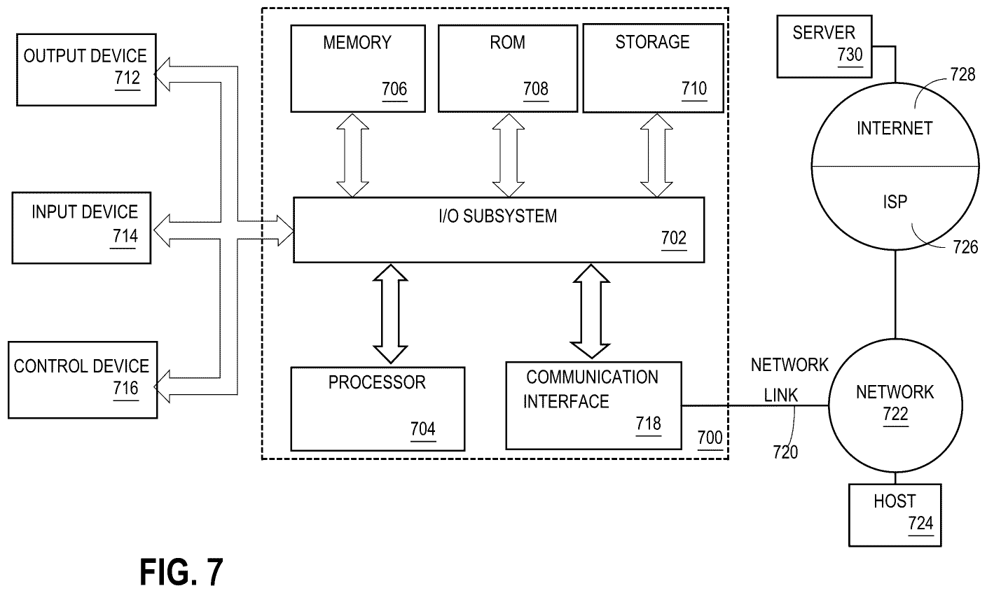

FIG. 7 is a block diagram that illustrates an example computer system with which an embodiment may be implemented. In the example of FIG. 7, a computer system 700 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 700 includes an input/output (I/O) subsystem 702 which may include a bus and/or other communication mechanism(s) for communicating information and/or instructions between the components of the computer system 700 over electronic signal paths. The I/O subsystem 702 may include an I/O controller, a memory controller, and at least one I/O port. The electronic signal paths are represented schematically in the drawings, for example as lines, unidirectional arrows, or bidirectional arrows.

At least one hardware processor 704 is coupled to I/O subsystem 702 for processing information and instructions. Hardware processor 704 may include, for example, a general-purpose microprocessor or microcontroller and/or a special-purpose microprocessor such as an embedded system, a graphics processing unit (GPU), a digital signal processor, or an Advanced RISC Machine (ARM, wherein RISC is short for Reduced Instruction Set Computer) processor. Processor 704 may comprise an integrated arithmetic logic unit (ALU) or may be coupled to a separate ALU.

Computer system 700 includes one or more units of memory 706, such as a main memory, which is coupled to I/O subsystem 702 for electronically digitally storing data and instructions to be executed by processor 704. Memory 706 may include volatile memory such as various forms of random-access memory (RAM) or another dynamic storage device. Memory 706 also may be used for storing temporary variables or other intermediate information during the execution of instructions to be executed by processor 704. Such instructions, when stored in non-transitory computer-readable storage media accessible to processor 704, can render computer system 700 into a special-purpose machine that is customized to perform the operations specified in the instructions.

Computer system 700 further includes non-volatile memory such as read only memory (ROM) 708 or other static storage device coupled to I/O subsystem 702 for storing information and instructions for processor 704. The ROM 708 may include various forms of programmable ROM (PROM) such as erasable PROM (EPROM) or electrically erasable PROM (EEPROM). A unit of persistent storage 710 may include various forms of non-volatile RAM (NVRAM), such as FLASH memory, solid-state storage, magnetic disk, or optical disk such as CD-ROM or DVD-ROM and may be coupled to I/O subsystem 702 for storing information and instructions. Storage 710 is an example of a non-transitory computer-readable medium that may be used to store instructions and data which when executed by the processor 704 cause performing computer-implemented methods to execute the techniques herein.

The instructions in memory 706, ROM 708, or storage 710 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG, or PNG; user interface instructions to render or interpret commands for a graphical user interface (GUI), command-line interface, or text user interface; application software such as an office suite, internet access applications, design and manufacturing applications, graphics applications, audio applications, software engineering applications, educational applications, games, or miscellaneous applications. The instructions may implement a web server, web application server, or web client. The instructions may be organized as a presentation layer, application layer, and data storage layer such as a relational database system using a structured query language (SQL) or no SQL, an object store, a graph database, a flat file system, or other data storage.

Computer system 700 may be coupled via I/O subsystem 702 to at least one output device 712. In one embodiment, output device 712 is a digital computer display. Examples of a display that may be used in various embodiments include a touchscreen display, a light-emitting diode (LED) display, a liquid crystal display (LCD), or an e-paper display. Computer system 700 may include other type(s) of output devices 712, alternatively or in addition to a display device. Examples of other output devices 712 include printers, ticket printers, plotters, projectors, sound cards, video cards, speakers, buzzers, piezoelectric devices, other audible devices, lamps, LED indicators, LCD indicators, haptic devices, actuators, or servos.

At least one input device 714 is coupled to I/O subsystem 702 for communicating signals, data, command selections, or gestures to processor 704. Examples of input devices 714 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, cellular, Wi-Fi, radio frequency (RF), infrared (IR), and/or Global Positioning System (GPS) transceivers.

Another type of input device is a control device 716, which may perform cursor control or other automated control functions such as navigation in a graphical interface on a display screen, alternatively or in addition to input functions. Control device 716 may be a touchpad, a mouse, a trackball, or cursor direction keys for communicating direction information and command selections to processor 704 and for controlling cursor movement on display 712. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or another type of control device. An input device 714 may include a combination of multiple different input devices, such as a video camera and a depth sensor.

In another embodiment, computer system 700 may comprise an internet of things (IoT) device in which one or more of the output device 712, input device 714, and control device 716 are omitted. Or, in such an embodiment, the input device 714 may comprise one or more cameras, motion detectors, thermometers, microphones, seismic detectors, other sensors or detectors, measurement devices, or encoders, and the output device 712 may comprise a special-purpose display such as a single-line LED or LCD display, one or more indicators, a display panel, a meter, a valve, a solenoid, an actuator, and/or a servo.

When computer system 700 is a mobile computing device, input device 714 may comprise a global positioning system (GPS) receiver coupled to a GPS module that is capable of (1) triangulating to a plurality of GPS satellites and (2) determining and generating geo-location or position data such as latitude-longitude values for a geophysical location of the computer system 700. Output device 712 may include hardware, software, firmware and interfaces for generating position reporting packets, notifications, pulse or heartbeat signals, or other recurring data transmissions that specify a position of the computer system 700, alone or in combination with other application-specific data, directed toward host 724 or server 730.

Computer system 700 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 700 in response to processor 704 executing at least one sequence of at least one instruction contained in main memory 706. Such instructions may be read into main memory 706 from another storage medium, such as storage 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire, and fiber optics, including the wires that comprise a bus of I/O subsystem 702. Transmission media can also take the form of acoustic or light waves, such as those generated during radio-wave and infra-red data communications.

Various forms of media may be involved in carrying at least one sequence of at least one instruction to processor 704 for execution. For example, the instructions may initially be carried on a magnetic disk or solid-state drive of a remote computer. The remote computer can load the instructions into its dynamic memory and send the instructions over a communication link such as a fiber optic cable, coaxial cable, or telephone line using a modem. A modem or router local to computer system 700 can receive the data on the communication link and convert the data to a format that can be read by computer system 700. For instance, a receiver such as a radio frequency antenna or an infrared detector can receive the data carried in a wireless or optical signal and appropriate circuitry can provide the data to I/O subsystem 702 such as place the data on a bus. I/O subsystem 702 carries the data to memory 706, from which processor 704 retrieves and executes the instructions. The instructions received by memory 706 may optionally be stored on storage 710 either before or after execution by processor 704.

Computer system 700 also includes a communication interface 718 coupled to I/O subsystem 702. Communication interface 718 provides a two-way data communication coupling to network link(s) 720 that are directly or indirectly connected to at least one communication network, such as a network 722 or a public or private cloud on the Internet. For example, communication interface 718 may be an Ethernet networking interface, integrated-services digital network (ISDN) card, cable modem, satellite modem, or a modem to provide a data communication connection to a corresponding type of communications line, for example, an Ethernet cable, a metal cable of any kind, a fiber-optic line, or a telephone line. Network 722 broadly represents a local area network (LAN), wide-area network (WAN), campus network, internetwork, or any combination thereof. Communication interface 718 may comprise a LAN card to provide a data communication connection to a compatible LAN or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 718 sends and receives electrical, electromagnetic, or optical signals over signal paths that carry digital data streams representing various types of information.

Network link 720 typically provides electrical, electromagnetic, or optical data communication directly or through at least one network to other data devices, using, for example, satellite, cellular, Wi-Fi, or BLUETOOTH technology. For example, network link 720 may provide a connection through a network 722 to a host computer 724.

Furthermore, network link 720 may provide a connection through network 722 or to other computing devices via internetworking devices and/or computers that are operated by an Internet Service Provider (ISP) 726. ISP 726 provides data communication services through a world-wide packet data communication network represented as internet 728. A server computer 730 may be coupled to internet 728. Server 730 broadly represents any computer, data center, virtual machine, virtual computing instance with or without a hypervisor, or computer executing a containerized program system such as DOCKER or KUBERNETES. Server 730 may represent an electronic digital service that is implemented using more than one computer or instance and that is accessed and used by transmitting web services requests, uniform resource locator (URL) strings with parameters in HTTP payloads, API calls, app services calls, or other service calls. Computer system 700 and server 730 may form elements of a distributed computing system that includes other computers, a processing cluster, a server farm, or other organization of computers that cooperate to perform tasks or execute applications or services. Server 730 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG, or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games, or miscellaneous applications. Server 730 may comprise a web application server that hosts a presentation layer, application layer, and data storage layer such as a relational database system using a structured query language (SQL) or no SQL, an object store, a graph database, a flat file system, or other data storage.

Computer system 700 can send messages and receive data and instructions, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage 710, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 704. While each processor 704 or core of the processor executes a single task at a time, computer system 700 may be programmed to implement multitasking to allow each processor to switch between tasks that are being executed without having to wait for each task to finish. In an embodiment, switches may be performed when tasks perform input/output operations when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising, executed using one or more computing devices:
accessing historical data associated with events in a procure-to-pay (P2P) process, the historical data comprising a plurality of records specifying numbers of days between historic requisitions and approval of historic purchase orders associated with the historic requisitions;
creating and storing a first procurement model based at least in part on the historical data, the first procurement model being programmed to predict a first amount and a first transaction data;
receiving a request for a requisition;
inputting the request for the requisition to the first procurement model and automatically predicting the first amount and the first transaction data for a requisition-to-purchase-order cycle time if the request for the requisition is processed using the P2P process;
determining an actual first amount and an actual first transaction data for the requisition-to-purchase-order cycle time when a first purchase order associated with the request for the requisition is generated and updating the historical data with the actual first amount and the actual first transaction data for the requisition-to-purchase-order cycle time of the P2P process;
creating and storing a second procurement model based at least in part on the historical data and the first purchase order, the second procurement model being programmed to predict a second amount and a second transaction data for a purchase-order-to-invoice cycle time of the P2P process;
inputting the first purchase order to the second procurement model and automatically predicting the second amount and the second transaction data for the purchase-order-to-invoice cycle time if the first purchase order is processed using the P2P process;
in response to receiving an invoice associated with the first purchase order, determining an actual second amount and an actual second transaction data for the purchase-order-to-invoice cycle time, and updating the historical data with the actual second amount and the actual second transaction data;
creating and storing a third procurement model based at least in part on the historical data and the invoice, the third procurement model being programmed to predict a third amount and a third transaction data for an invoice approval cycle time of the P2P process;
in response to the invoice being approved for payment, inputting the invoice to the third procurement model and automatically determining an actual third amount and an actual third transaction data for the invoice approval cycle time, and updating the historical data with the actual third amount and the actual third transaction data for the invoice approval cycle time of the P2P process;
outputting the first, second, and third amounts and the first, second, and third transaction data for the requisition-to-purchase-order cycle time, the purchase-order-to-invoice cycle time, and the invoice approval cycle time of the P2P process;
generating a work order by evaluating the first, second, and third amounts and the first, second, and third transaction data for the requisition-to-purchase-order cycle time, the purchase-order-to-invoice cycle time, and the invoice approval cycle time of the P2P process and causing a display of the work order on a user interface of a client device.

2. The computer-implemented method of claim 1, further comprising applying the work order in multiple enterprise resource planning (ERP) systems to cause consolidating a total number of vendors.

3. The computer-implemented method of claim 1, further comprising determining the first, second, and third amounts based at least in part on the received request for the requisition, the first purchase order, and the invoice.

4. The computer-implemented method of claim 1, wherein the first, second, and third transaction data include a date value, a possibility value of the date value, and a duration period for a requisition-to-purchase-order-approval cycle time, the purchase-order-to-invoice cycle time, and the invoice approval cycle time of the P2P process.

5. The computer-implemented method of claim 4, the first, second, and third procurement models comprising a statistical model;
the method further comprising:
determining the date value based at least in part on a mean value of the statistical model;
determining the possibility value of the date value based at least in part on a probability value corresponding to the mean value in the statistical model;
determining the duration period based at least in part on the mean value and two (2) standard deviations in the statistical model.

6. The computer-implemented method of claim 5, wherein the statistical model is based at least in part on a Gaussian distribution.

7. The computer-implemented method of claim 1, wherein the invoice approval cycle time comprises invoice-to-payment-batch cycle time, invoice-payment-batch-approval cycle time, and batch release cycle time based on different payment terms.

8. The computer-implemented method of claim 1, further comprising obtaining the historical data from P2P process, travel, and expense objects from one or more of an e-procurement application, travel application, and expense application of a federated system in which the method executes, wherein the historical data comprise records digitally stored in a database with column attributes for industry, supplier, and spend amount.

9. The computer-implemented method of claim 8, further comprising obtaining the historical data as de-identified community data from a plurality of enterprises.

10. A computer system, comprising:
one or more processors; and
a memory coupled to the processors comprising instructions executable by the processors, the processors operable when executing the instructions to:
receive a historical data and a requisition request;
generate a first procurement model based at least in part on the historical data and the requisition request to predict a first amount and a first transaction data for a requisition-to-purchase-order cycle time of a procure-to-pay (P2P) process;
predict the first amount and the first transaction data for the requisition-to-purchase-order cycle time of the P2P process based at least in part on the requisition request and the first procurement model;
determine an actual first amount and an actual first transaction data for the requisition-to-purchase-order cycle time when a purchase order associated with the requisition request is generated by a company, wherein the historical data are updated with the actual first amount and the actual first transaction data for the requisition-to-purchase-order cycle time of the P2P process;
generate a second procurement model based at least in part on the historical data and the generated purchase order to predict a second amount and a second transaction data for a purchase-order-to-invoice cycle time of the P2P process;
predict the second amount and the second transaction data for the purchase-order-to-invoice cycle time of the P2P process based at least in part on the generated purchase order and the second procurement model;
determine an actual second amount and an actual second transaction data for the purchase-order-to-invoice cycle time when an invoice associated with the purchase order is received by the company, wherein the historical data are updated with the actual second amount and the actual second transaction data for the purchase-order-to-invoice cycle time of the P2P process;
generate a third procurement model based at least in part on the historical data and the received invoice to predict a third amount and a third transaction data for invoice approval cycle time of the P2P process;
determine an actual third amount and an actual third transaction data for the invoice approval cycle time when an invoice associated with the purchase order is approved for payment by the company, wherein the historical data are updated with the actual third amount and the actual third transaction data for the invoice approval cycle time of the P2P process;
output the first, second, and third amounts and the first, second, and third transaction data for the requisition-to-purchase-order cycle time, the purchase-order-to-invoice cycle time, and the invoice approval cycle time of the P2P process;
generate a work order by evaluating the first, second, and third amounts and the first, second, and third transaction data for the requisition-to-purchase-order cycle time, the purchase-order-to-invoice cycle time, and the invoice approval cycle time of the P2P process to improve short-term and long-term liquidity planning;
cause display of the work order on a user interface of a client device.

11. The computer system of claim 10, wherein the work order is applied in multiple enterprise resource planning (ERP) systems to consolidate a total number of vendors and streamline business expenditures by lowering at least one requisition cost.

12. The computer system of claim 10, wherein the first, second, and third amounts are determined based at least in part on the received requisition, the generated purchase order, and the received invoice from the company.

13. The computer system of claim 10, wherein the first, second, and third transaction data include a date value, a possibility value of the date value, and a duration period for a requisition-to-purchase-order-approval cycle time, the purchase order or invoice cycle time, and the invoice approval cycle time of the P2P process.

14. The computer system of claim 13, wherein each of the first, second, and third procurement models is a statistical model, wherein the date value is determined based at least in part on a mean value in the statistical model, wherein the possibility value of the date value is determined based at least in part on a probability value corresponding to the mean value in the statistical model, and
wherein the duration period is determined based at least in part on the mean value and two (2) standard deviations in the statistical model.

15. The computer system of claim 14, wherein the statistical model is based at least in part on a Gaussian distribution.

16. The computer system of claim 10, wherein the invoice approval cycle time comprises invoice-to-payment-batch cycle time, invoice-payment-batch-approval cycle time, and batch release cycle time based on different payment terms.

17. The computer system of claim 10, wherein the historical data comprise historical records from P2P process, travel, and expense objects, wherein the historical data are industry-specific, supplier-specific, and spend-specific, where the historical data is from the company, and wherein the historical data is from a community data from other companies or a public source.

18. The computer system of claim 10, wherein a cash flow associated with the P2P process is a cost of contingent works in the P2P process for the company.

19. One or more non-transitory computer-readable storage media storing one or more sequences of instructions which, when executed using one or more processors, cause the one or more processors to execute:
receive a historical data and a requisition request;
generate a first procurement model based at least in part on the historical data and the requisition request to predict a first amount and a first transaction data for requisition-to-purchase-order cycle time of a procure-to-pay (P2P) process;
predict the first amount and the first transaction data for the requisition-to-purchase-order cycle time of the P2P process based at least in part on the requisition request and the first procurement model;
determine an actual first amount and an actual first transaction data for the requisition-to-purchase-order cycle time when a purchase order associated with the requisition request is generated by a company, wherein the historical data are updated with the actual first amount and the actual first transaction data for the requisition-to-purchase-order cycle time of the P2P process;
generate a second procurement model based at least in part on the historical data and the generated purchase order to predict a second amount and a second transaction data for a purchase-order-to-invoice cycle time of the P2P process;
predict the second amount and the second transaction data for the purchase-order-to-invoice cycle time of the P2P process based at least in part on the generated purchase order and the second procurement model;
determine an actual second amount and an actual second transaction data for the purchase-order-to-invoice cycle time when an invoice associated with the purchase order is received by the company, wherein the historical data are updated with the actual second amount and the actual second transaction data for the purchase-order-to-invoice cycle time of the P2P process;
generate a third procurement model based at least in part on the historical data and the received invoice to predict a third amount and a third transaction data for invoice approval cycle time of the P2P process;
determine an actual third amount and an actual third transaction data for the invoice approval cycle time when an invoice associated with the purchase order is approved for payment by the company, wherein the historical data are updated with the actual third amount and the actual third transaction data for the invoice approval cycle time of the P2P process;
output the first, second, and third amounts and the first, second, and third transaction data for the requisition-to-purchase-order cycle time, the purchase-order-to-invoice cycle time, and the invoice approval cycle time of the P2P process;
generate a work order by evaluating the first, second, and third amounts and the first, second, and third transaction data for the requisition-to-purchase-order cycle time, the purchase-order-to-invoice cycle time, and the invoice approval cycle time of the P2P process to improve short-term and long-term liquidity planning;
cause display of the work order on a user interface of a client device.

20. The non-transitory computer-readable storage media of claim 19, wherein the work order is applied in multiple enterprise resource planning (ERP) systems to consolidate a total number of vendors and streamline business expenditures by lowering at least one requisition cost.
